(19) United States
(12) Patent Application Publication
(10) Pub. No.: US 2004/0228695 A1
(43) Pub. Date: Nov. 18, 2004

(54) Methods and devices for adjusting the shape of a rotary bit

(76) Inventor: Luke W. Clauson, Redwood Shores, CA (US)

Correspondence Address: HOEKENDIJK & LYNCH, LLP, P.O. BOX 4787, BURLINGAME, CA, 94011-4787, US

(21) Appl. No.: 10/750,997

(22) Filed: Dec. 31, 2003

Related U.S. Application Data
(60) Provisional application No. 60/437,375, filed on Jan. 1, 2003.

(51) Int. Cl. B23B 51/00

(52) U.S. Cl. 408/161

(57) ABSTRACT

A rotary cutting tool using insert type knives or blades (a) 12. An adjustor 14 interfaces with the blades (a) 12, precisely and equally moving the blades inward or outward with respect to the axis of the cutting tool. The adjustor 14 may be actuated by turning with a tool or by hand, thus changing the cutting diameter or profile of the cutting tool. Blade set screws 16 are provided to lock the position of the blades (a) 12 once the desired adjustment has been accomplished.

### CROSS-REFERNCE TO RELATED APPLICATIONS

This application claims the benefit of Ser. No. 60/437375, filed Jan. 1, 2003 by Luke W Clauson.

### BACKGROUND OF THE INVENTION—FIELD OF INVENTION

This invention relates to rotary bits, specifically adjustable diameter and profile bits for use with hand held routers, router tables, drills, mills, and any other devices utilizing a spinning tool to cut material.

### BACKGROUND OF THE INVENTION

Router bits are available from many companies nationally and internationally in various shapes, sizes and profiles. There are many designs with respect to blade configurations, profiles and sizes for various purposes. Currently, if one wants to create a slot or profile in a material with a router bit, one must use the correspondingly sized and shaped bit. This becomes problematic when the end user's need is not matched by a commonly manufactured size or shape. To solve this problem, one must either do multiple passes with a smaller sized bit or partial profile bits to create a larger slot or custom shaped profile. One can also order a custom sized bit from a manufacturer. Neither of these options are practical or cost effective for many users as they require a significant increase in machining time or a vast and expensive inventory of sizes and shapes. It also can cost valuable shop time as projects are held up for custom bit arrival.

Examples of woodworking and metalworking rotary tooling utilizing replaceable insert cutters are known. They are commonly seen in application such as wood shaper heads and metal milling machine shell and end mills. In U.S. Pat. No. 3,688,367 (1972) to Bennett, for example, a rotary cutter having replaceable cutter inserts (blades) and means to slightly adjust them for proper insert to insert alignment. Bennett describes essentially a fixed diameter or profile cutting tool with replaceable inserts and a means to properly set them. In U.S. Pat. No. 4,243,348 (1981) to Paige a rotary cutter for a milling machine is described. The cutter insert is clamped in the head of the tool by a clamp member without means for significant diameter adjustment. If a tool diameter is to be adjusted a variation of the holder must be used. Adjustment of a cutter profile by manually positioning cutter inserts at a desired angle and then clamping them in position is possible. Finally, in U.S. Pat. No. 5,593,253 (1997) to Pozzo a router bit with interchangeable knives is disclosed. The bit like the others uses insert knives or cutters. The cutters may be readjusted by hand to the initial diameter to account for cutter wear or resharpening.

### BACKGROUND OF THE INVENTION—OBJECTS AND ADVANTAGES

The present invention provides a device, system and method which allow the user to significantly adjust the diameter and profile of the bit to the needed size and/or shape.

The present invention provides a bit which can have a diameter ranging from 0.7 inches to 0.8 inches. Another individual bit could accomplish 0.4 to 0.6 inch slots etc. The range is infinitely adjustable and is not comprised of stepped variation as is commonly found on large shaper tooling. Another example arises when a user machines a chamfer. Presently, one must buy a specific angle chamfer bit. The present invention allows the user to infinitely adjust the angle on a chamfering bit between two end angles. For example one bit might serve as a 30 degree chamfer, a 60 degree chamfer as well as all angles in between. The ability to vary the size and profile of the bit allow for application specific machining with fewer tools and reduced cost.

Still further objects and advantages will become apparent from consideration of the ensuing description and drawings.

### SUMMARY

Consistent with the present invention, a bit with provision for user adjustment according to immediate custom size or profile requirements.

### DRAWINGS—FIGURES

FIG. 1A shows an isometric perspective of an adjustable diameter straight bit.

FIG. 1B shows an exploded view of the bit in FIG. 1A.

FIG. 1C shows a top view of the bit in FIG. 1A set at its minimum diameter.

FIG. 1D shows a top view of the bit in FIG. 1A set at an intermediate diameter.

FIG. 1E shows a top view of the bit in FIG. 1A set at its maximum diameter.

FIG. 2A shows an isometric exploded view of bit with a profile adjustment system.

FIG. 2B shows a blade of the bit in FIG. 2A.

FIG. 2C a side view of the bit in FIG. 2A set a low angle.

FIG. 2D a side view of the bit in FIG. 2A set a high angle.

FIG. 3A shows an isometric perspective of an alternate embodiment adjustable diameter straight bit.

FIG. 3B shows a blade of the bit in FIG. 3A.

FIG. 3C an exploded view of the bit in FIG. 3A.

FIG. 3D shows a cutaway side view of the bit in FIG. 3A.

FIG. 4 shows an alternate embodiment blade for use with bit in FIG. 1A-1E.

FIG. 5 shows an alternate embodiment blade for use with bit in FIG. 2A-2D.

FIG. 6 shows a base with provision for offset blades.

FIG. 7A shows an exploded view of a screw adjusted straight bit.

FIG. 7B shows the details of the blade included in FIG. 7A.

FIG. 7C shows a double screw adjustor used for the bit in FIG. 7A.

FIG. 7D shows a cut away view of the fully assembled bit in FIG. 7A.

FIG. 8A shows an assembled single blade dovetail bit.

FIG. 8B shows a cut away view of the base of FIG. 8A.

FIG. 8C shows and exploded view of the bit in FIG. 8A.

FIG. 8D shows the details of the blade included in FIG. 8A.

### DETAILED DESCRIPTION—PREFERED EMBODIMENTS

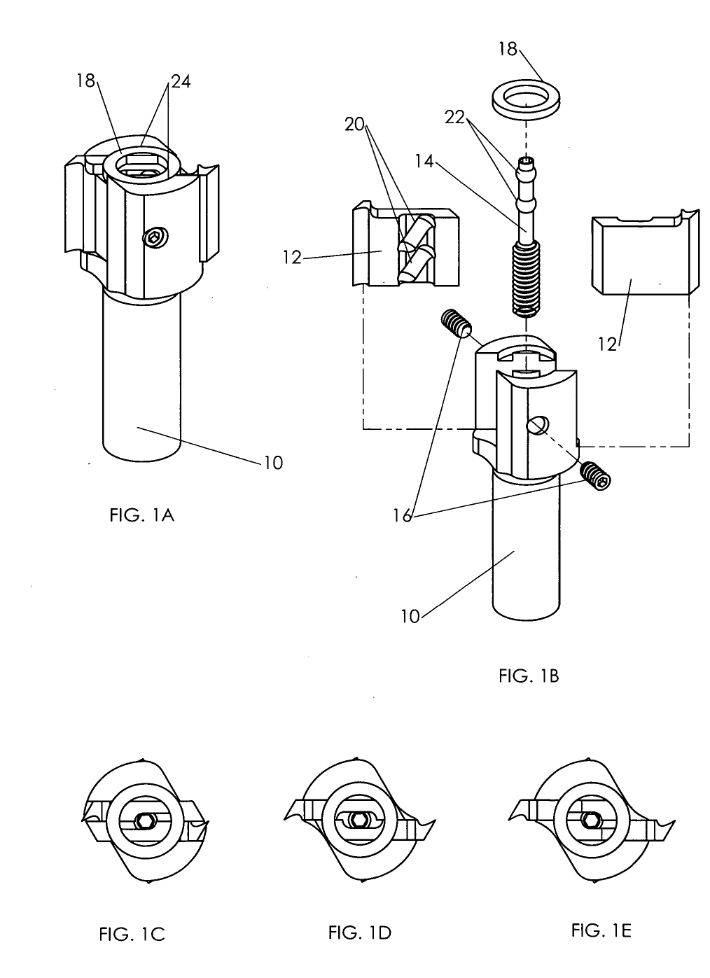

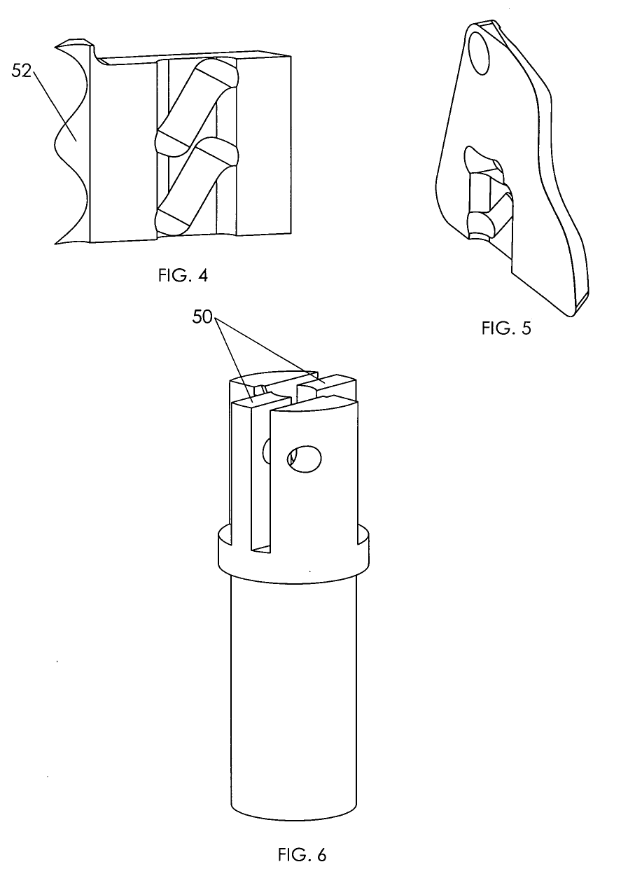

An embodiment of the invention is illustrated in FIGS. 1A-1E which depict the invention in a simple manifestation: a straight, two bladed router bit. Of course, the bit may be used in any other rotary cutting machine and, further, may have an angled bit or take any other shape other than straight. The bit includes a base (a) 10, a pair of cutting elements 11 or blades (a) 12, an adjustor or actuator 14 and at least two blade set screws 16. The blades slip into the base (a) 10 around the adjustor 14 which screws into the shank of the bit base (a) 10. The blades (a) 12 include adjustor sphere followers 20, hemispherically shaped slots that interface with adjustor spheres 22 on adjustor 14. Once the blades (a) 12 are in the base (a) 10 and correctly interfaced with the adjustor spheres 22 a base ring 18 is secured in place to lock the whole assembly together. The base ring 18 can be replaced with any piece of material that can bridge the slot in the base (a) 10 and be joined to the base (a) 10. The adjustor 14 centers the blades as well as moves them in or out equally. The bottom and or top of the adjustor 14 has a screwdriver slot or hex key cut into it to facilitate turning it when adjustment is necessary. The adjustor 14 may be extended to protrude beyond the bottom of the base (a) 10 to facilitate finger adjustment. Blade set screws (16) secure the blades (a) 12 in the base (a) 10 during operation. Standard machining processes such as conventional turning/milling, wire EDM, sinker EDM, forging, coining, grinding, casting, rolling etc. can be utilized in manufacture of some or all of the components. Any metal, ceramic, composite or other strong, stiff material can be used for each component. Specifically, steel is a good choice for the components. Carbide blades or blade tips may be used to increase durability and performance over longer usage cycles. At the base (a) ring interface 24 the base ring 18 may be joined to the base (a) 10 by any welding process, brazing process or other joining process. The blades (a) 12 in this system can employ any edge profile (such as an ogie) that may be desired (such as shown in FIG. 4). The base (a) 10 can also be adapted to include a bearing post on the top of the base (a) 10 as a variant, for use in machining operations such as rabbiting.

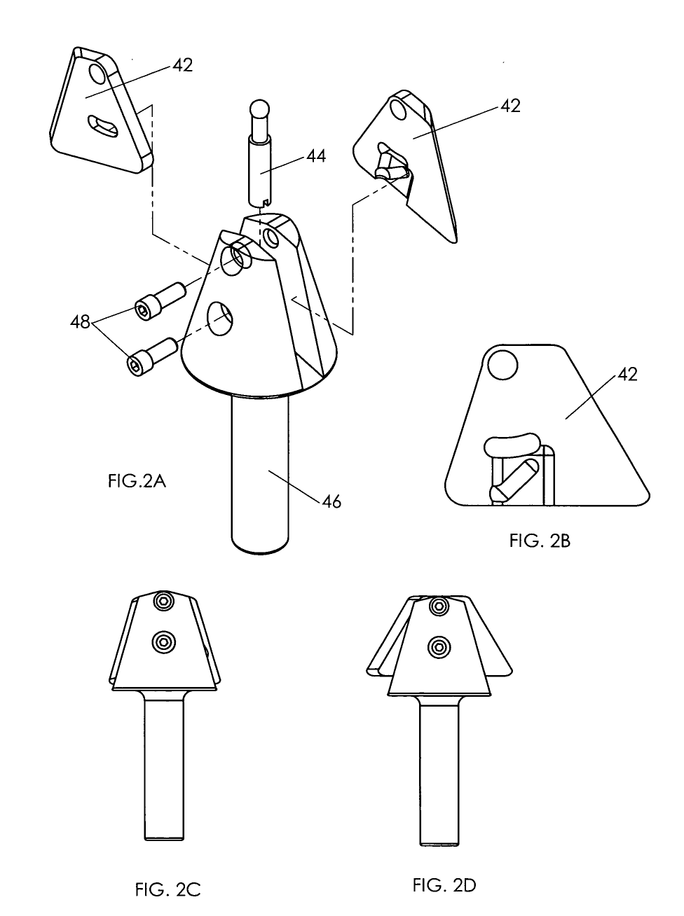

Another embodiment of the invention is illustrated in FIGS. 2A-2D which depict a chamfering, two bladed router bit. The present invention includes a base (c) 46, blades (c), a chamfer adjustor 44 and at least two blade lock screws (b) 48. The blades (c) or cutting elements (c) 42 slip into the base (c) 46 around the chamfer adjustor or actuator 44, which screws into the shank of the base (c) 46. The bottom of the chamfer adjustor 44 has a screwdriver slot or hex key cut into it to facilitate turning it when adjustment is necessary. The uppermost of the two blade lock screws (b) 48 passes through the hole in both blades (c) 42 and screws into the other side of the base (c) 46. The bottom blade lock screw (b) 48 passes through slots in the blades (c) 42 and screws into the other side of the base (c) 46. When tightened, these screws secure the blades in place for operation. Any or all of the manufacturing methods and materials described herein may be appropriate for this system as well. This system may also use carbide or carbide tipped blades (c) 42. This system can be very easily extended to include other blade edge or cutting edge profiles, such as ogies and bullnose cutters (see FIG. 5), which when combined with the adjustability of the whole assembly become even more versatile than they are currently.

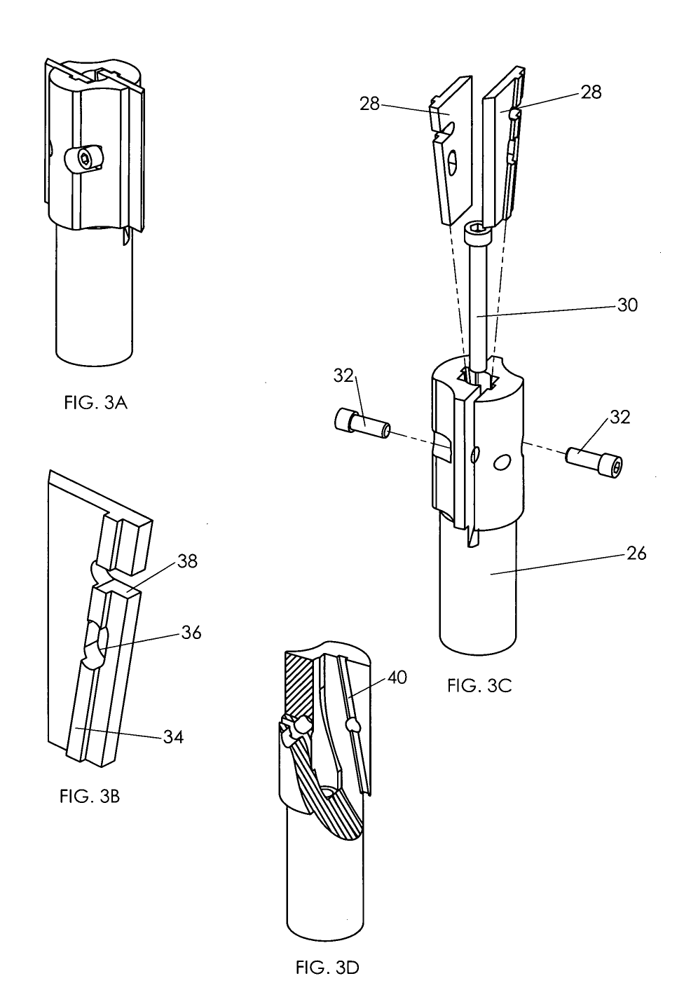

FIG. 3A-3E shows still another embodiment of the present invention. It is another straight, two-blade router bit but, of course, may take any other suitable shape or may be a bit used in any other rotary cutting tool or machine. The bit includes a base (b) 26, two blades (b) 28 or cutting elements 28, an adjustor screw 30, at least two blade lock screws 32. The blades (b) 28 slip into the base (b) 26 around the adjustor screw 30, who's head interfaces with the blade adjustor screw slot 38. The blades (b) 28 have a blade key 34 bosses on their back faces that mate with corresponding base (b) keyway 40. The blade key 34 and base (b) keyway 40 allow for precise location of each blade as well as positive blade retention. Finally, blade lock screws 32 are screwed into base (b), extending through blade lock screw slots 36 in each corresponding blade (b) 28, securing the blades in place. The angle of the blade key 34 and the corresponding base (b) keyway 40 may be varied in the design to change the rate at which the blades are diametrally adjusted by the adjustor screw 30. Carbide blades may be used or carbide tips may be joined to non-carbide blades (b) 28. All methods of manufacture mentioned herein may be employed for some or all of the components of this embodiment. Again, steel is a suitable material choice but some or all of the components may be made of other sufficiently strong materials.

FIG. 6 shows a router bit base similar to those shown in FIG. 1 It is distinguished by its provision for an offset between the blades. This variation can be applied to the adjustment systems detailed in all of the embodiments above, with slight modification of the adjustor 14 (FIG. 1B), chamfering adjustor 44 (FIG. 2A) or adjustor screw 30 (FIG. 3C), respectively. Each of these adjustment means would need larger interfacing features so as to bridge the larger gap between the blades due to the web (50) in the base. The advantage of separating blades is increased rake angle, which is beneficial in some machining operations. Other than the material web left on the base between the blades and the modified adjustment means, the other design details remain unchanged.

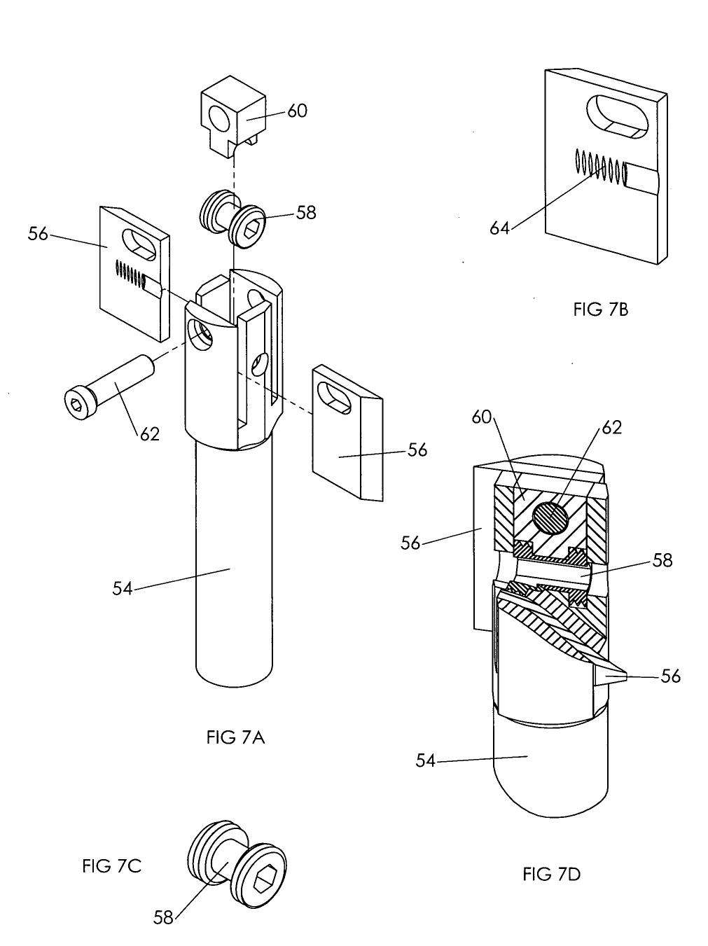

FIGS. 7A-7D show a straight router bit that can be adjusted while leaving the bit in the router or similar machine. The bit includes a base (d) 54 which has slots to accept blades (d) 56. The base (d) 54 is recessed to hold the double screw adjustor 58 which interfaces with the threads of the screw adjustor interface 64. The double screw adjustor 60 consists of a pair of opposite direction threads connected by a smaller diameter cylindrical bridge. There exists a hexagonal hole through the cylindrical axis of the component to facilitate adjustment with an allen key. Turning the double adjustor screw 58 moves the blades (d) 56 in or out equally, thereby adjusting the cutting diameter of the bit. The adjustor retainer 60 is inserted into the base (d) 54, capturing the double screw adjustor 58. The blade lock screw (c) 62 is inserted in side of the base (d) 54, through the blades (d) 56 and adjustor retainer 60 and screws into the other side of the base (d) 54. The blades lock screw (c) 62 is tightened to lock the blades (d) 56 after the double screw adjustor 58 has been turned to adjust the bit cutting diameter.

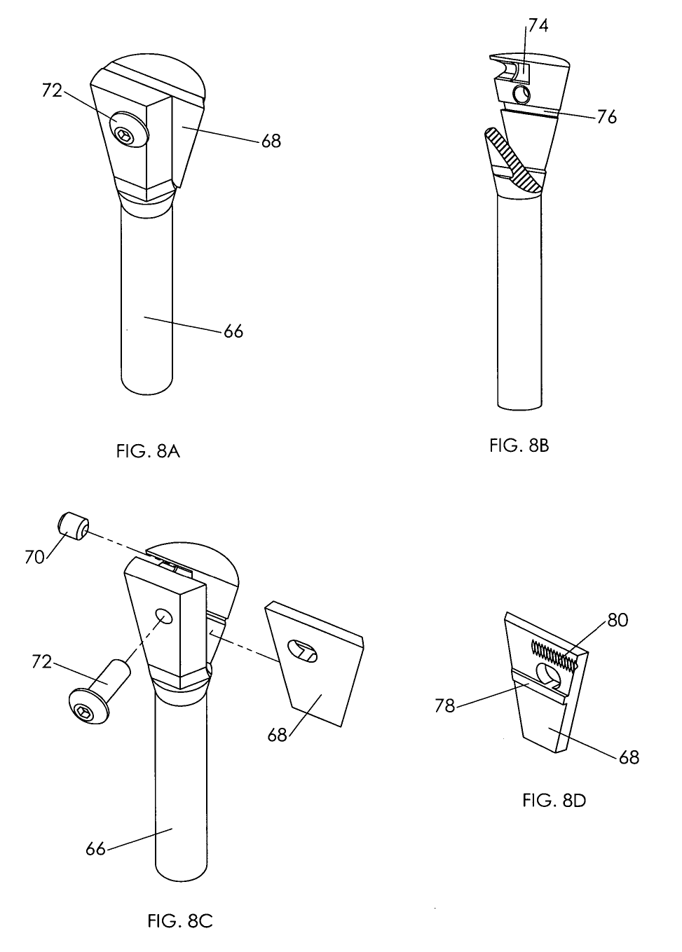

FIGS. 8A-8D show a single blade adjustable dovetail router bit. The bit is comprised of a base (e) 68 with a slot to accept the blade (e) 68. The blade (e) 68 has a blade alignment rib 78 as well as a set screw adjustor interface 80 on its back face. The base has a recessed set screw adjustor pocket 74 which accepts the set screw adjustor 70. The blade (e) 68 slides into the base guided by the blade alignment rib 78 which keys into the base (e) keyway 76. As the blade (e) 68 slides into place the set screw adjustor 70 must be turned to engage with the threads of the set screw adjustor interface 80. When the bit is fully assembled, a blade lock screw (d) 72 passes into one side of base (e) 66 through a slot in the blade (e) 68 and screws into the back side of base (e) 66. The blade alignment rib 78 and associated base feature provide consistent blade (e) 68 base (e) 66 alignment as the bit is adjusted. This alignment feature can be included on any of the blades (cutting elements) and bases in FIGS. 1A-1E, FIG. 6 and FIGS. 7A-7D. The single blade construction in FIGS. 8A-8D is particularly useful for small diameter bits and dovetail bits but can be applied as effectively to straight bits as well.

Finally, a front relief 52 angle can be ground onto any of the blade faces to increase cutting performance. FIG. 4 shows a blade with a relief 52. Tapered relief grooves may be used to create a slight up-cut or down-cut effect.

The various embodiments of the present invention may provide at least a 10% increase in the cutting element diameter and more preferably at least a 15% increase in cutting element diameter when moving from the smallest to largest diameter. In another aspect, several of the bits described herein have actuators or adjustors which are rotatable about an axis which is colinear with the axis of rotation of the bit. In this manner, the size and general configuration of the bit may simplified while still permitting the size adjustments described herein. Although the axis of rotation of the actuator or adjustor may be colinear with the axis or rotation of the bit, the adjustor axis is preferably less than 10 degrees from the axis or rotation of the bit and, of course, is preferably colinear.

### OPERATION

There is little difference in the basic methods of utilization between these bits and bits that are currently available to the consumer. Once they are adjusted to meet the user's requirements they are simply inserted into the router or other rotary tool and used in a conventional manner. All designs described herein may utilize user replaceable blades which may be changed with like or differently shaped blades in the field. Of course, various aspects of the operation may be performed in a different manner than described herein without departing from the scope of the invention. Adjustment may be accomplished as follows:

FIGS. 1A-1E:

1. User determines custom requirements and selects the appropriate adjustable bit.

2. User loosens the blade set screws 16, thus freeing the blades (a) 12.

3. User inserts appropriate screwdriver or hex key into top or bottom of adjustor 14.

4. User turns adjustor 14 until blades (a) 12 are at the desired position. The adjustment is accomplished by the vertical translation of the adjustor spheres 22 within the interfacing adjustor sphere followers 20 in the blades (a) 12, forcing the blades outwards.

5. User tightens blade set screws 16, which bear against the back side of the blades (a) 12, securing them into position for use.

FIGS. 2A-2D:

1. User determines custom requirements and selects the appropriate adjustable bit.

2. User loosens the blade lock screws (b) 48.

3. User inserts appropriate screwdriver or hex key into the bottom of chamfer adjustor 44.

4. User turns chamfer adjustor 44 until blades (c) 42 are at the desired position. The adjustment is accomplished by the same affect as described above for the diametral expansion system, except that only the base of each of the blades (c) 42 are forced outwards, thus changing the blade angle.

5. User tightens blade lock screws (b) 48 to secure blades (c) 42 into position.

FIGS. 3A-3E:

1. User determines custom requirements and selects the appropriate adjustable bit.

2. User loosens the blade lock screws 32.

3. User inserts appropriate screwdriver or hex key into the top of the adjustor screw 30.

4. User turns adjustor screw 30 until blades (b) 28 are at the desired position. This adjustment is accomplished by the adjustor screw 30, who's head interfaces with the blade adjustor screw slot 38. When the adjustor screw 30 translates vertically it drives the blades up or down. Since the blade key 34 interfaces with the angled base (b) keyway 40, any vertical motion of the blades (b) 28 also has a horizontal component, which changes the overall diameter of the bit.

5. User tightens blade lock screws 32 to secure blades (b) 28 into position.

FIGS. 7A-7D:

1. User determines custom requirements and selects the appropriate adjustable bit.

2. User loosens the blade lock screw (c) 62.

3. User turns double screw adjustor 58 until blades (d) 56 are in the desired position. This is accomplished as the threads on the double screw adjustor 58 interface with the screw adjustor interface 64 on the front face of each of the blades (d) 56. One end of the double screw adjustor 58 moves one of the blades (d) 56 while the opposite direction thread on the other end of the set screw adjustor 58 equally moves the other blade 56 in the opposite direction.

4. User tightens the blade lock screw (c) 62 to secure blades (d) 56 into position.

FIGS. 8A-8D:

1. User determines custom requirements and selects the appropriate adjustable bit.

2. User loosens the blade lock screw (d) 72.

3. User inserts allen key into and turns the set screw adjustor 70. The set screw adjustor 70 interfaces with the treads of the set screw adjustor interface 80, driving the blade (e) 68 in or out. The blade alignment rib 78 maintains the blade's 68 alignment to the base (e) 66.

4. User tightens to the blade lock screw (d) 72 to secure the blade (e) into position.

As is evident by the preceding description a rotary cutting tool as described, provides significant advantages to a user. The flexibility and efficiency with which a custom profile or feature can be created is dramatically increased with this invention. Those working with wood, plastic and even metal can employ variations of these rotary bits to increase their productivity, design flexibility and accuracy while milling material.

The above description contains many specificities which are not intended to limit the scope of the invention. Though many variations are possible those listed are intended to demonstrate the intent of the described invention. Thus, the scope of the invention should be determined not by the embodiments illustrated, but by the appended claims and their legal equivalents.

1. A bit for a rotary cutting tool, comprising:
a body having a longitudinal axis;
a first cutting element coupled to the body, the cutting element having a cutting surface positioned radially outward from the body, the cutting element also having a threaded region; and
a rotatable actuator coupled to the cutting element, the actuator having a threaded section which matingly engages the threaded region on the cutting element, the actuator being movable between a first position and a second position, wherein at least part of the cutting surface moves radially outward when the actuator moves from the first position to the second position.

2. The bit for a rotary cutting tool of claim 1, further comprising:
a second cutting element coupled to the body, the second cutting element having a second cutting surface;
wherein movement of the actuator from the first position to the second position also moves at least part of the second cutting element radially outward.

3. The bit for a rotary cutting tool of claim 2, wherein:
the first and second cutting elements are moved the same amount by the actuator when the actuator moves from the first position to the second position.

4. The bit for a rotary cutting tool of claim 1, wherein:
the actuator is positionable at any intermediate position between the first and second positions.

5. The bit for a rotary cutting tool of claim 1, wherein:
the first cutting element changes in angular orientation with respect to the longitudinal axis when the actuator moves from the first position to the second position.

6. The bit for a rotary cutting tool of claim 1, further comprising:
a locking element which is movable from an unlocked position to a locked position, the locking element permitting movement of the actuator and the first cutting element when in the unlocked position and preventing movement of the actuator and first cutting element when in the locked position.

7. A bit for a rotary cutting tool, comprising:
a body having a longitudinal axis, the body being rotated around the longitudinal axis when mounted to a rotary cutting tool;
a first cutting element coupled to the body, the first cutting element having a cutting surface positioned radially outward from the body; and
a rotatable actuator coupled to the cutting element, the actuator being rotatable about an axis which is less than 10 degrees from the longitudinal axis of the body, wherein rotation of the actuator moves the actuator longitudinally between a first position and a second position, at least part of the cutting surface moving radially outward when the actuator moves from the first position to the second position.

8. The bit for a rotary cutting tool of claim 7, further comprising:
a second cutting element coupled to the body, the second cutting element having a second cutting surface;
wherein movement of the actuator from the first position to the second position also moves at least part of the second cutting element radially outward.

9. The bit for a rotary cutting tool of claim 8, wherein:
the first and second cutting elements are moved the same amount by the actuator when the actuator moves from the first position to the second position.

10. The bit for a rotary cutting tool of claim 7, wherein:
the actuator is positionable at any intermediate position between the first and second positions.

11. The bit for a rotary cutting tool of claim 7, wherein:
the first cutting element changes in angular orientation with respect to the longitudinal axis when the actuator moves from the first position to the second position.

12. The bit for a rotary cutting tool of claim 7, wherein:
the actuator has a first engagement surface which engages the first cutting element; and
the first cutting element has a first groove in which the first engagement surface is positioned.

13. The bit for a rotary cutting tool of claim 7, wherein:
the first engagement surface is substantially spherical.

14. The bit for a rotary cutting tool of claim 7, further comprising:
a second cutting element having a second groove;
the actuator being positioned in the second grooves to move the second cutting element when the actuator moves from the first position to the second position.

15. The bit for a rotary cutting tool of claim 14, wherein:
the first engagement surface is positioned in the first and second grooves.

16. The bit for a rotary cutting tool of claim 14, wherein:
the actuator has a second engagement surface spaced apart from the first engagement surface, the second engagement surface being positioned in the second groove.

17. The bit for a rotary cutting tool of claim 7, further comprising:
a locking element which is movable from an unlocked position to a locked position, the locking element permitting movement of the actuator and the first cutting element when in the unlocked position and preventing movement of the actuator and first cutting element when in the locked position.

18. The bit for a rotary cutting tool of claim 7, wherein:
the axis of rotation of the actuator is colinear with the longitudinal axis of the body.

19. A bit for a rotary cutting tool, comprising:
a body having a longitudinal axis;
a first cutting element coupled to the body, the first cutting element having a first cutting surface positioned radially outward from the body;
a second cutting element coupled to the body, the second cutting element having a second cutting surface positioned radially outward from the body;
an actuator coupled to the first and second cutting elements, the actuator being movable between a first position and a second position, wherein at least part of the first and second cutting surfaces move radially outward when the actuator moves from the first position to the second position.

20. The bit for a rotary cutting tool of claim 19, wherein:
the actuator is a rotatable element having an axis of rotation.

21. The bit for a rotary cutting tool of claim 19, wherein:
the axis of rotation of the rotatable element is less than 10 degrees from the longitudinal axis of the body.

22. The bit for a rotary cutting tool of claim 19, wherein:
the first and second cutting elements are moved the same amount by the actuator when the actuator moves from the first position to the second position.

23. The bit for a rotary cutting tool of claim 19, wherein:
the actuator is positionable at any intermediate position between the first and second positions.

24. The bit for a rotary cutting tool of claim 19, wherein:
the cutting element changes in angular orientation with respect to the longitudinal axis when the actuator moves from the first position to the second position.

25. The bit for a rotary cutting tool of claim 19, wherein:
the actuator has a first engagement surface which engages the first cutting element; and
the first cutting element has a first groove in which the first engagement surface is positioned.

26. The bit for a rotary cutting tool of claim 19, wherein:
the first engagement surface is substantially spherical.

27. The bit for a rotary cutting tool of claim 19, wherein:
the second cutting element has a second groove;
the actuator being positioned in the second groove to move the second cutting element when the actuator moves from the first position to the second position.

28. The bit for a rotary cutting tool of claim 27, wherein:
the first engagement surface is positioned in the first and second grooves.

29. The bit for a rotary cutting tool of claim 19, wherein:
the actuator has a second engagement surface spaced apart from the first engagement surface, the second engagement surface being positioned in the second groove.

30. The bit for a rotary cutting tool of claim 19, further comprising:
a locking element which is movable from an unlocked position to a locked position, the locking element permitting movement of the actuator and the first cutting element when in the unlocked position and preventing movement of the actuator and first cutting element when in the locked position.

31. The bit for a rotary cutting tool of claim 19, wherein:
an axis of rotation of the actuator is colinear with the longitudinal axis of the body.

32. A bit for a rotary cutting tool, comprising:
a body having a longitudinal axis;
a first cutting element coupled to the body, the cutting element having a cutting surface positioned radially outward from the body;
an actuator coupled to the cutting element, the actuator being movable between a first position and a second position, the actuator moving longitudinally when moving from the first position to the second position, wherein at least part of the cutting surface moves radially outward when the actuator moves longitudinally from the first position to the second position.

33. The bit for a rotary cutting tool of claim 32, further comprising:
a second cutting element coupled to the body, the second cutting element having a second cutting surface;
wherein movement of the actuator from the first position to the second position also moves at least part of the second cutting element radially outward.

34. The bit for a rotary cutting tool of claim 33, wherein:
the first and second cutting elements are moved the same amount by the actuator when the actuator moves from the first position to the second position.

35. The bit for a rotary cutting tool of claim 32, wherein:
the actuator is positionable at any intermediate position between the first and second positions.

35. The bit for a rotary cutting tool of claim 32, wherein:
the first cutting element changes in angular orientation with respect to the longitudinal axis when the actuator moves from the first position to the second position.

36. The bit for a rotary cutting tool of claim 32, wherein:
the actuator has a first engagement surface which engages the first cutting element; and
the first cutting element has a first groove in which the first engagement surface is positioned.

37. The bit for a rotary cutting tool of claim 32, wherein:
the first engagement surface is substantially spherical.

38. The bit for a rotary cutting tool of claim 32, further comprising:
a second cutting element having a second groove;
the actuator being positioned in the second grooves to move the second cutting element when the actuator moves from the first position to the second position.

39. The bit for a rotary cutting tool of claim 38, wherein:
the first engagement surface is positioned in the first and second grooves.

40. The bit for a rotary cutting tool of claim 38, wherein:
the actuator has a second engagement surface spaced apart from the first engagement surface, the second engagement surface being positioned in the second groove.

41. The bit for a rotary cutting tool of claim 32, further comprising:
a locking element which is movable from an unlocked position to a locked position, the locking element permitting movement of the actuator and the first cutting element when in the unlocked position and preventing movement of the actuator and first cutting element when in the locked position.

42. The bit for a rotary cutting tool of claim 32, wherein:
the actuator is rotatable about an axis of rotation.

43. The bit for a rotary cutting tool of claim 42, wherein:
the axis of rotation of the rotatable element is less than 10 degrees from the longitudinal axis of the body.

44. The bit for a rotary cutting tool of claim 42, wherein:
the axis of rotation of the actuator is colinear with the longitudinal axis of the body.

45. A bit for a rotary cutting tool, comprising:
a body having a longitudinal axis;
a first cutting element coupled to the body, the cutting element having a cutting surface positioned radially outward from the body;
an actuator coupled to the first cutting element, the actuator being movable between a first position and a second position, wherein the angular orientation of the cutting surface relative to the longitudinal axis changes when the actuator moves from the first position to the second position.

46. The bit for a rotary cutting tool of claim 45, further comprising:
a second cutting element coupled to the body, the second cutting element having a second cutting surface;
wherein movement of the actuator from the first position to the second position also moves at least part of the second cutting element radially outward.

47. The bit for a rotary cutting tool of claim 46, wherein:
the first and second cutting elements are moved the same amount by the actuator when the actuator moves from the first position to the second position.

48. The bit for a rotary cutting tool of claim 45, wherein:
the actuator is positionable at any intermediate position between the first and second positions.

49. The bit for a rotary cutting tool of claim 45, wherein:
the cutting element changes in angular orientation with respect to the longitudinal axis when the actuator moves from the first position to the second position.

50. The bit for a rotary cutting tool of claim 45, wherein:
the actuator has a first engagement surface which engages the first cutting element; and
the first cutting element has a first groove in which the first engagement surface is positioned.

51. The bit for a rotary cutting tool of claim 45, wherein:
the first engagement surface is substantially spherical.

52. The bit for a rotary cutting tool of claim 45, further comprising:
a second cutting element having a second groove;
the actuator being positioned in the second grooves to move the second cutting element when the actuator moves from the first position to the second position.

53. The bit for a rotary cutting tool of claim 52, wherein:
the first engagement surface is positioned in the first and second grooves.

54. The bit for a rotary cutting tool of claim 52, wherein:
the actuator has a second engagement surface spaced apart from the first engagement surface, the second engagement surface being positioned in the second groove.

55. The bit for a rotary cutting tool of claim 45, further comprising:
a locking element which is movable from an unlocked position to a locked position, the locking element permitting movement of the actuator and the first cutting element when in the unlocked position and preventing movement of the actuator and first cutting element when in the locked position.

56. The bit for a rotary cutting tool of claim 45, wherein:
the axis of rotation of the actuator is colinear with the longitudinal axis of the body.

57. The bit for a rotary cutting tool of claim 45, wherein:
the actuator is rotatable about an axis of rotation.

58. The bit for a rotary cutting tool of claim 57, wherein:
the axis of rotation of the rotatable element is less than 10 degrees from the longitudinal axis of the body.

59. The bit for a rotary cutting tool of claim 57, wherein:
the axis of rotation of the actuator is colinear with the longitudinal axis of the body.
